(19) United States
(12) Patent Application Publication
(10) Pub. No.: US 2014/0122483 A1
(43) Pub. Date: May 1, 2014

(54) SYSTEM AND METHOD FOR DETERMINING A DURATION FOR USER ACTIVITIES BASED ON SOCIAL-NETWORK EVENTS

(71) Applicant: PALO ALTO RESEARCH CENTER INCORPORATED, Palo Alto, CA (US)

(72) Inventors: Rui Zhang, San Francisco, CA (US); Robert R. Price, Palo Alto, CA (US); Oliver Brdiczka, Mountain View, CA (US)

(73) Assignee: PALO ALTO RESEARCH CENTER INCORPORATED, Palo Alto, CA (US)

(21) Appl. No.: 13/662,273

(22) Filed: Oct. 26, 2012

(51) Int. Cl. G06F 17/30

(52) U.S. Cl. 707/737; 707/758; 707/E17.089; 707/E17.032

(57) ABSTRACT

An activity-modeling system computes an amount of time that a user is expected to spend when performing activities of a certain type. During operation, the system can obtain a plurality of location events associated with the user, such that a respective location event indicates a time at which a user logged his location while performed an activity related to the activity type. The system selects, from the plurality of location events, a set of location events associated with the activity type. The system determines an activity start-time and an activity end-time for the activity type from the set of location events, and computes an activity-duration time for the activity type based on the determined activity start-time and the activity end-time.

### BACKGROUND

1. Field

This disclosure is generally related to modeling a user's behavior and activities. More specifically, this disclosure is related to determining an activity duration for user activities based on location information that users share using social-media services.

2. Related Art

Advances in portable Internet-enabled computing technologies have made it easier for people to share and receive content while on the go. To take advantage of these portable computing capabilities and people's desire to share information, many entrepreneurs have produced online social-media services that allow people to share their social experiences with the general public in the form of micro-blogs or user-generated reviews. These social-media services also allow people to use their portable devices to search for recommendations for new places to visit or new activities to explore.

Some of these social-media services, such as Facebook and Twitter, allow their members to choose who should be allowed to see the information they share, which further encourages their members to share more sensitive information such as their current location. Also, some of these social-media services provide incentives for their members to share their location often. For example, Foursquare assigns a high-ranking “badge” (e.g., “mayor”) to a user that visits a location more frequently than others, and oftentimes provides “specials” to these users and to other users that frequently share information. However, aside from all the benefits that these services provide to their members, these social-media services are having a difficult time to monetize on their large user base.

One revenue source is to provide paid advertisements or recommendations to users based on the activities they are performing. Unfortunately, not many users pay attention to these advertisements or recommendations because they are oftentimes delivered either too early or too late. For example, a user that has just finished dining out is not likely to care about a coupon to a nearby restaurant, or a user that has just arrived home from dining out may not likely care about a coupon to a new blockbuster movie. On the other hand, if the user were to receive a recommendation for the new movie as the user is finishing dinner with friends, the user and his friends may decide to go watch the movie instead of calling it a night. It is oftentimes difficult to predict when to deliver an advertisement or a recommendation to a person given that the amount of time that a person spends performing an activity varies significantly from person to person, and from activity to activity.

### SUMMARY

One embodiment provides an activity-modeling system that computes an amount of time that a user is expected to spend when performing activities of a certain type. During operation, the system can obtain a plurality of location events associated with the user, such that a respective location event indicates a time at which a user logged his location while performed an activity related to the activity type. The system selects, from the plurality of location events, a set of location events associated with the activity type. The system determines an activity start-time and an activity end-time for the activity type from the set of location events, and computes an activity-duration time for the activity type based on the determined activity start-time and the activity end-time.

In some embodiments, the location event also indicates at least one of: a user identifier; a geographic location; a text description of a location; a venue identifier; a venue type; a text description of a venue; an activity identifier; an activity type; and a text description of the activity.

In some embodiments, the activity duration indicates one or more of: a commute time between venues for a first activity and a second activity; a time interval between a first activity and a second activity; a wait period before performing an activity; a preparation time for an activity; and a participation time for an activity.

In some embodiments, while selecting the set of location events associated with the activity type, the system determines whether the user's location events correspond to a trace of periodic location events or a trace of manual location events.

In some embodiments, responsive to determining that the location events correspond to a trace of periodic location events, the system detects one or more location-event sequences from the plurality of location events. A respective location-event sequence includes location events that correspond to a common activity. The system selects the set of location events to include a sequence of location events for one or more activities of the activity type.

In some embodiments, while determining the activity start-time and activity end-time, the system selects the activity start-time for a respective activity based on an earliest location event for the respective activity's location-event sequence. The system also selects the activity end-time for the respective activity based on a latest location event for the respective activity's location-event sequence.

In some embodiments, while computing the activity duration for the activity type, the system computes an activity duration for a respective activity based on the determined activity start-time and activity end-time for the respective activity. The system then computes an average duration for the activity type based on activity durations for one or more activities of the activity type.

In some embodiments, in response to determining that the location events correspond to a trace of manual location events, the system identifies one or more users with a similar behavior pattern, and selects the set of location events to include events for the activity type from the one or more users. The system then determines a first cluster of location events associated with an activity start-time from the set of location events. The system also determines a second cluster of location events associated with an activity end-time from the set of location events.

In some embodiments, while determining the activity start-time for the activity type, the system computes an average time value for the first cluster. Also, while determining the activity end-time for the activity type, the system computes an average time value for the second cluster.

In some embodiments, identifying the one or more similar users involves determining that the one or more users have similar parameters for one or more of: a work schedule; a commute schedule; a sleep schedule; a geographic location; a job title; a career type; an activity type; and a geographic location.

### BRIEF DESCRIPTION OF THE FIGURES

FIG. 1 illustrates an exemplary computer system that facilitates computing an activity-duration time for an activity type in accordance with an embodiment.

FIG. 2 presents a flow chart illustrating a method for computing an activity-duration time for an activity type in accordance with an embodiment.

FIG. 3 presents a flow chart illustrating a method for determining how to process a user's location events in accordance with an embodiment.

FIG. 4 presents a flow chart illustrating a method for computing the activity-duration time directly from the user's location events in accordance with an embodiment.

FIG. 5 presents a flow chart illustrating a method for computing the activity-duration time by detecting a pattern using location events from a plurality of users in accordance with an embodiment.

FIG. 6 illustrates exemplary location-event clusters in accordance with an embodiment.

FIG. 7 illustrates an exemplary apparatus that facilitates computing an activity-duration time for an activity type in accordance with an embodiment.

FIG. 8 illustrates an exemplary computer system that facilitates computing an activity-duration time for an activity type in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure.

Thus, the present invention is not limited to the embodiments shown, but is to be accorded the widest scope consistent with the principles and features disclosed herein.

### Overview

Embodiments of the present invention solve the problem of providing an activity-modeling system that can estimate an amount of time that a person spends on a certain activity or type of activity. The system can gather historical location information for a user or various users by accessing various social-media and location-based services, and can analyze this information to determine how much time the user or a group of users spends performing an activity.

For example, some people may have a smartphone or phone service that routinely tracks their location (e.g., periodically at predetermined time intervals), and that makes their location trace available to a third-party service. In exchange for sharing their location information, the third-party service can reward users with incentives (e.g., a coupon) to return to a favorite venue or to visit a new venue that may be of interest to the users. The activity-analyzing system can analyze these location traces to compute an average activity-duration that a user (or a user demographic) spends on a certain activity or type of activity.

Unfortunately, many users prefer to not have their location-enabled device track their location, and/or they prefer not to provide their real-time location trace to a third-party service. Some smartphone users may not want their smartphone to use battery power for polling their location, while other users may prefer not to let others know their whereabouts at every moment for security reasons. In either case, these users may be selective as to when they decide to share their location information with others.

For example, users that visit a popular venue may indicate to others that they have visited the venue through one or more various techniques. Some users may decide to share their location information on a location-based service that provides incentives (e.g., Foursquare), or they may reveal their location on a user-review service (e.g., Yelp). Further, some users may post their location on an online social network for others to see (e.g., via Facebook, Twitter, Tumblr, etc.), or they may share their location via any other service now known or later developed.

In some embodiments, the activity-analyzing system can obtain location events for a plurality of users from these various sources, and analyzes these location events to compute an expected activity-duration for a certain activity or type of activity. The location event can indicate a timestamp and a location (e.g., a geographic location or a location identifier) for the location event, a user identifier for the user performing the activity, a venue type for the location, an activity identifier or activity type for the user's current activity, and/or any user-generated content (e.g., a picture, audio, video, a list of participants, and/or a text description of the activity).

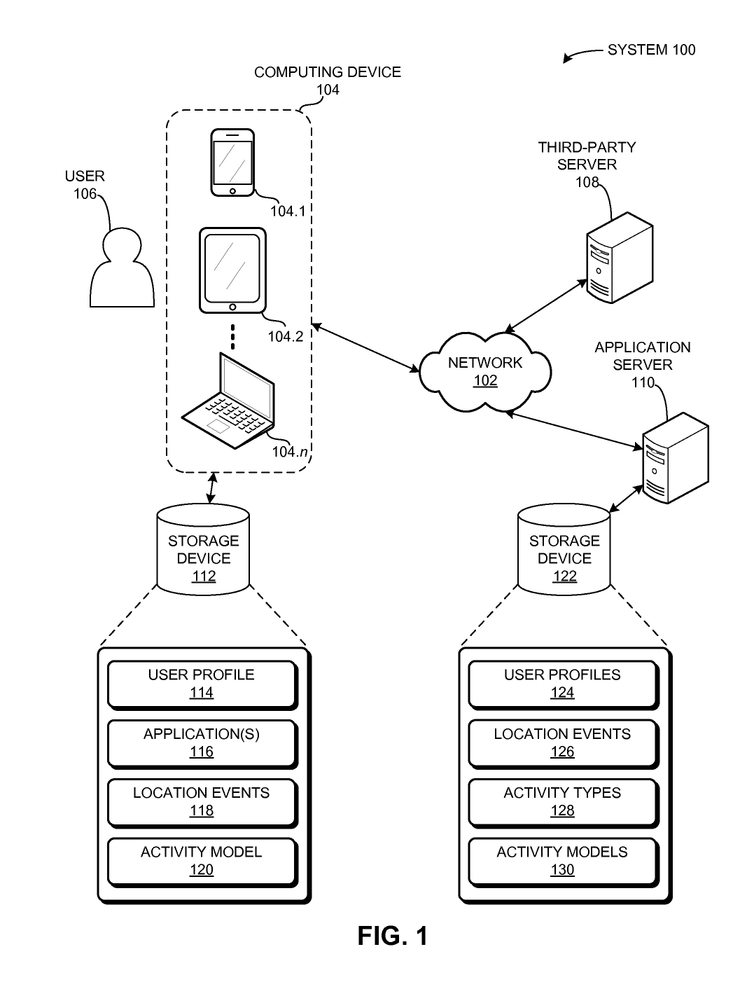

FIG. 1 illustrates an exemplary computer system 100 that facilitates computing an activity-duration time for an activity type in accordance with an embodiment. Computer system 100 can include a computer network 102, which can include any wired or wireless network that interfaces various computing devices to each other, such as a computer network implemented via one or more technologies (e.g., Bluetooth, Wi-Fi, cellular, Ethernet, fiber-optic, etc.).

Computer system 100 can also include a computing device 104 coupled to network 102 and associated with a user 106, such as an portable computing device that user 106 can travel with, use to communicate with others, perform tasks, and manage a personal or shared calendar. For example, computing device 104 can include a smartphone 104.1, a tablet computer 104.2, or any other personal computing device 104.n such as a laptop computer, a desktop computer, etc.

As user 106 performs activities throughout the day, user 106 can use computing device 104 to share information about his location and/or information related to the activities that user 106 is performing. For example, user 106 can configure computing device 104 to periodically determine location information about user 106 (e.g., using a location sensor embedded within or attached to computing device 104), and to upload this location information to a third-party server 108 (e.g., a social-media service). Thus, third-party server 108 may store a location trace from one or more computing devices 104 owned by user 106, such that this location trace indicates a location for user 106 as user 106 performs activities throughout his day (e.g., travels to certain locations, meets with others, visits a restaurant or any other type of venue, etc.).

As another example, user 106 can manually interact with an application on computing device 104 (e.g., a Web browser or any other application executing on computing device 104) to provide a current location to third-party server 108. Thus, user 106 may be selective as to which locations and activities he decides to share via third-party server 108. User 106 may share his location via a location-based service shortly after entering a venue (e.g., after being seated at a restaurant and before looking at the menu), and/or shortly before leaving the venue (e.g., to recommend the venue to friends or write a revue for the general public). In some embodiments, computing device 104 can gather additional contextual information associated with user 106 and the location. This additional contextual information can include information that identifies a venue at the sampled location (e.g., a store name, a business, a homeowner, etc.), identifies typical activities performed at the sampled location, identifies others close to user 106 (e.g., based on a Bluetooth or Wi-Fi signal detected from their mobile devices), etc.

During operation, an application server 110 can obtain location information (and any relevant contextual information), for user 106 and/or other users, from computing device 104 and/or third-party server 108. Application server 110 can analyze the gathered location information to identify activities performed by user 106, and to determine an activity-duration for each activity that user 106 has performed.

Application server 110 may also provide services to user 106. Application server 110 may automatically maintain a collection of scheduled activities for user 106 based on an expected duration for these activities. Also, Application server 110 may recommend activities to add to a schedule for user 106 based on an expected duration for the recommended activity. Application server 110 may also recommend advertisements and/or incentives (e.g., coupons, gifts, etc.) for user 106 based on his current or scheduled activity and the duration for the activity (e.g., to provide the advertisement and/or incentive to user 106 shortly before the user finishes one activity and/or shortly before user 106 begins another activity).

Further, application server 110 may inform computing device 104 of an expected duration for a current activity being performed by user 106, which can allow device 104 to schedule certain notifications or interactions with user 106 based on certain time windows that user 106 may be busy or available to interact with device 104. For example, computing device 104 can use a known commute time to work do determine how soon to provide a reminder to user 106 (e.g., remind user 106 of a meeting with enough time for user 106 to commute work). Also, if computing device 104 knows a duration for a typical meeting, computing device 104 can determine an amount of time to place a smartphone on mute and/or to refrain from displaying non-critical messages to user 104 (e.g., based on a whitelist and/or a blacklist of sources and/or message subjects).

In some embodiments, computing device 104 can include or be coupled to a storage device 112, which can store a use profile 114 for user 106, application(s) 116, and location-events 118. User profile 114 can include user-account information, address and contact information, as well as demographic information for user 106. Specifically, the user-account information may indicate user accounts for one or more social-media services (e.g., a service hosted by third-party server 108), which can be used by applications 116 and/or application server 110 to access third-party server 108 to obtain location event information associated with user 106.

The user-account information may also include tokens that can be used to allow an application 116 or application server 110 to access a social-media service on third-party server 108 without requiring user 106 to provide a password. For example, user 106 may use an account name and password to authenticate computing device 104 or application server 110 using an open-authorization protocol, which provides an authorization token to computing device 104 or application server 110. This authorization token grants application 116 or application server 110 access to some or all features from a user-account associated with user 106 (e.g., pictures, “friends,” visited locations, articles read, and/or any other user-behavior information). Applications 116 and/or application server 110 can use this authorization token to access third-party server 108 to obtain location event information associated with user 106.

Further, Applications 116 can generate location events 118 pertaining to user 106 either periodically or in response to a request from user 106, and can upload location events 118 to third-party server 108. If an application is periodically polling a location for user 106, computing device 104 can generate location events 118 to include a complete location trace for user 106. In some embodiments, computing device 104 can reduce a number of location events that are stored for user 106, for example, by only recording a location event when user 106 moves at least a threshold distance (e.g., 5 meters) from a recently recorded location event.

As another example, computing device 104 can perform geo-fencing to store only location events 118 for when user 106 moves near a border of a geo-location fence (e.g., a border for a geographic region that has been assigned to an activity or an activity type). Table 2 presents an exemplary sequence of periodic location events that have been filtered using geo-fencing in accordance with an embodiment.

TABLE 2

65905786|2011-01-24 06:59:13|1295881153|2011-01-24 13:59:13|
324199|-6.5617541|106.7318938|IPB Dramaga|105|
College & Education:University
65917051|2011-01-24 07:55:46|1295884546|2011-01-24 14:55:46|
324199|-6.5617541|106.7318938|IPB Dramaga|105|
College & Education:University
65917494|2011-01-24 07:57:54|1295884674|2011-01-24 14:57:54|
324199|-6.5617541|106.7318938|IPB Dramaga|105|
College & Education:University
6592060|2011-01-24 08:13:05|1295885585|2011-01-24 15:13:05|
324199|-6.5617541|106.7318938|IPB Dramaga|105|
College & Education:University
65928585|2011-01-24 08:57:30|1295888250|2011-01-24 15:57:30|
324199|-6.5617541|106.7318938|IPB Dramaga|105|
College & Education:University
65929089|2011-01-24 09:00:10|1295888410|2011-01-24 16:00:10|
324199|-6.5617541|106.7318938|IPB Dramaga|105|
College & Education:University

Storage device 112 can also store an activity model 120 for user 106. Computing device 104 may generate activity model 120 for user 106 based on location events 118, or can receive activity model 120 from application server 110. Activity model 120 can include location information associated with one or more activity types, and can include time-related information for the one or more activity types. For example, the model can include GPS coordinates and/or venue names associated with the activity type, and can indicate an activity-duration time that the user is expected to spend on these activities. Activity model 120 may also include schedule information for the activity type, such as days and times that user 106 is likely to perform activities of a certain activity type (e.g., a time of day, a day of the week, a day of the month, etc.), and/or future times that the user has scheduled to perform activities of a certain activity type. In some embodiments, computing device 104 can use activity model 120 to generate a recommendation for user 106 (e.g., an advertisement, a coupon, a task or schedule event, etc.).

In some embodiments, application server 110 can include or be coupled to a storage device 122, which can store use profiles 124 for a plurality of users 124, location-events 126 for the plurality of users, a pre-defined or user-defined collection of activity types 128, and activity models 130 for a plurality of various activities or activity types. During operation, application server 110 can obtain location events 126 associated with a plurality of users (e.g., via third-party server 108), and can generate activity models 130 for activity types 128 based on user profiles 124 and location events 126. Application server 110 can generate some activity models so that they are specific to an individual user, for example, by generating the activity model based on this user's past activity. Application server 110 can also generate some activity models so that they can predict an amount of time at which a user is likely to spend performing an activity based on behavior information from a group of similar individuals (e.g., a group of users that have substantially similar profile attributes).

### Activity-Modeling System

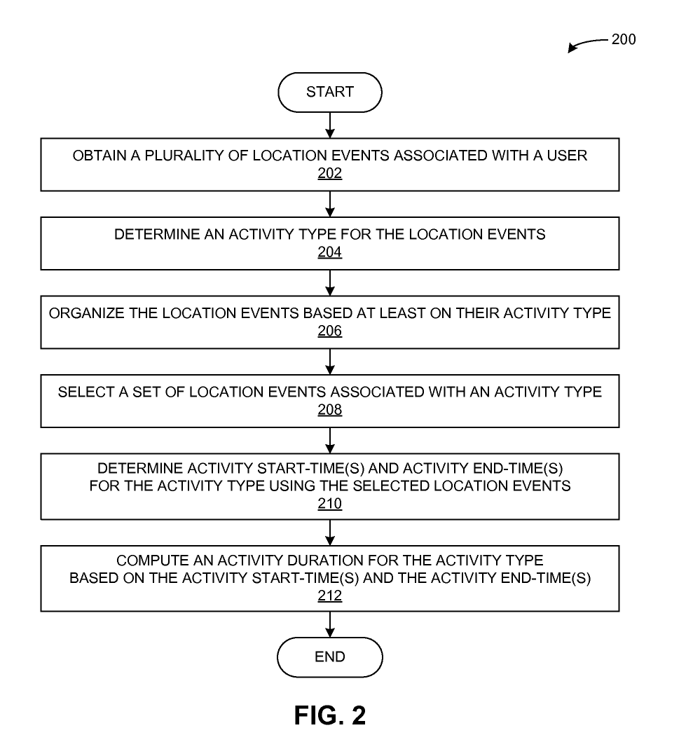

FIG. 2 presents a flow chart illustrating a method 200 for computing an activity-duration time for an activity type in accordance with an embodiment. During operation, the system obtains a plurality of location events associated with a user (operation 202). Each location event can indicate a venue or geographic location, and a timestamp. The system can determine an activity type for the location events (operation 204), and can also organize the location events based at least on their activity type (operation 206). For example, the system can assign to each location event one or more activity types that may describe the user's activity (e.g., at a coffee shop, grocery shopping, communing to/from work, etc.).

The system selects a set of location events associated with an activity type (operation 208), and determines activity start-time(s) and activity end-time(s) for the activity type using the selected location events (operation 210). The system then computes an activity-duration time for the activity type based on the activity start-time(s) and the activity end-times(s) (operation 212).

In some embodiments, the system can select the location events so that they include various different location traces of the same activity type for the user (e.g., location traces for various different coffee shops, or for various meetings with the same group of people regardless of the meeting location). If the system has a sufficient number of location events (e.g., the user's smartphone periodically gather's the user's location), the system can determine a duration for an activity directly from the user's location events.

However, it is possible that the system may not have a sufficient number of location events from the user to determine an activity-duration time for the activity type. In some variations, the system can combine the user's location activities with additional location activities from other similar users (e.g., other users with a similar behavior pattern or a similar demographic) to compute the activity-duration time for the activity type.

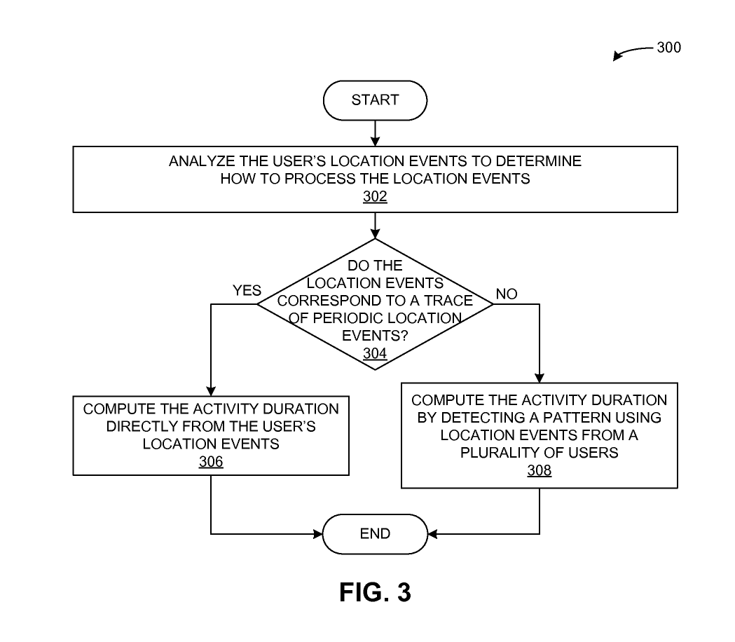

FIG. 3 presents a flow chart illustrating a method 300 for determining how to process a user's location events in accordance with an embodiment. During operation, the system analyzes the user's location events to determine how to process the location events (operation 302). For example, the system can analyze the user's location events to detect a pattern and/or frequency. The user's location events may include a periodic sequence of location events that trace the user's locations at a determinable frequency, and/or can include one or more location check-in events that were triggered manually by the user.

The system then determines whether the user's location events correspond to a trace of periodic location events (operation 304). If so, the system can compute the activity-duration time directly from the user's location events (operation 306). However, if the system determines that the user's location events are not periodic (or that there are not enough location events for the user or a certain activity type), the system can compute the activity-duration time by detecting a pattern using historical location events from the user's long-term activity history and/or from one or more users that have a similar behavior pattern to the user (operation 308).

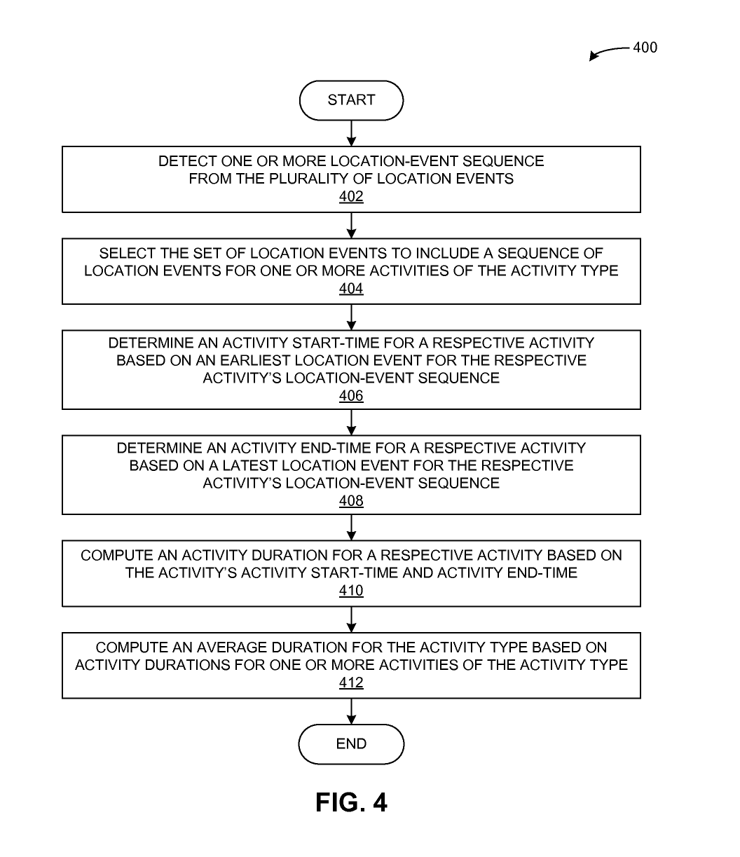

FIG. 4 presents a flow chart illustrating a method 400 for computing the activity-duration time directly from the user's location events in accordance with an embodiment. During operation, the system can detect one or more location event sequences from the user's plurality of location events (operation 402). Each detected sequence can include one or more location events (e.g., periodic venue or location identifiers) that are associated with an activity that the user has performed. For example, a location trace that corresponds to a user driving to work can include a starting location event for when the user is still at home, can include a variety of location events that correspond to the user's commute to work, and can end with a location event for when the user arrives at work. As another example, a location trace that corresponds to the user visiting a certain venue (e.g., a coffee shop or a restaurant) can include a sequence of periodic events that indicate the venue name or geographic location. The first location event in the sequence can include a timestamp for when the user arrived at the venue, and the last location event in the sequence can include a timestamp for when the user was last known to be at the venue.

Recall that the system can classify the user's location events by assigning one or more likely activity types to each location event. The system can use these assigned activity types to select the set of location events for a certain activity type (operation 404). For example, the system can select the set of location events to include a sequence of location events for one or more activities of the activity type.

In some embodiments, the system may select more than one location event sequences when the user has performed various activities that match the target activity type. To compute an activity-duration time for a respective activity, the system determines the respective activity's activity start-time based on an earliest location event from the corresponding location-event sequence (operation 406). The system also determines the respective activity's activity end-time based on a latest location event for the corresponding location-event sequence (operation 408). The system computes the activity-duration for time the respective activity using the activity start-time and end-time (operation 410), for example, by subtracting the activity start-time from the activity end-time.

The system then computes the average duration for the activity type using the activity-duration times for the one or more activities of the activity type (operation 412). For example, if the activity type corresponds to the user's visits to a coffee shop, the system can compute an average for the time that the user spends at various different coffee shop locations.

As another example, if the activity type corresponds to meetings in general, the system can compute the average length of a meeting based on the amount of time the user spends at meetings with various colleagues and/or clients. If the activity type corresponds to a particular type of meeting (e.g., a meeting with a colleague, or a meeting with a client), the system can compute the average length based only on previous meetings of the desired type. The system can determine the type of meeting for a location event, for example, based on the location and/or additional contextual information associated with the location event (e.g., by identifying others close to the user based on a detected Bluetooth or Wi-Fi signal from their mobile devices).

### Long-Term Pattern Analysis for Computing an Activity's Duration

Oftentimes users do not want their personal computing device(s) to periodically poll their location and send this information to a remote server for security reasons and/or because they may want to maximize their device's battery life between charges. If the system determines that the user's location events are not periodic, the system can compute the activity-duration time for an activity type by detecting a pattern using historical location events from the user's long-term activity history and/or from one or more users that have a similar behavior pattern to the user.

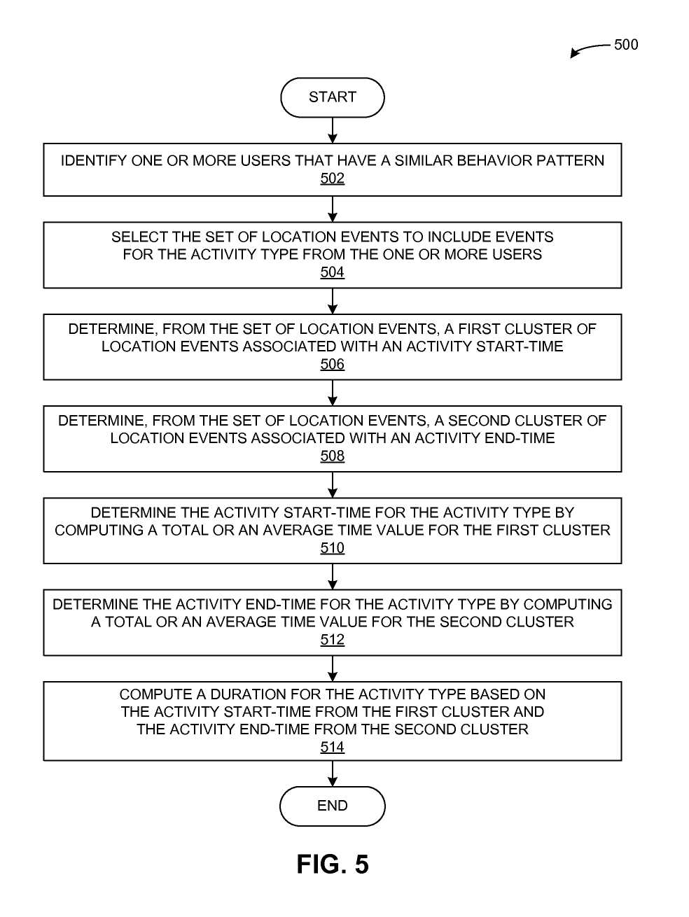

FIG. 5 presents a flow chart illustrating a method 500 for computing the activity-duration time by detecting a pattern using location events from a plurality of users in accordance with an embodiment. During operation, the system identifies one or more individuals that have a similar behavior pattern (operation 502). These individuals can include the user and/or other people that have a similar behavior pattern to the user.

In some embodiments, the system can identify the one or more users with a similar behavior pattern by searching for users that have one or more similar parameters in their user profiles and/or have similar behavior patterns. For example, the system can search for users that have a similar schedule (e.g., a work schedule, a commute schedule, or a sleep schedule), or that live or work within a common a geographic area (e.g., the same building or city block, the same city, the same state, etc.). The system can also search for users that have a similar job title or career type, perform similar activities (e.g., perform similar types hobbies, have similar exercise regimens, etc.), or have similar tastes (e.g., music, food, movies, articles, etc.).

The system then selects a set of location events that includes events for the activity type from the identified individuals (operation 504). These location events can include one-time location check-ins performed manually by the individual users. Oftentimes, each of the identified users checks-in his location at approximately the same time of his visit. For example, a user that is attempting to become a “mayor” of a venue on a location-based online service (e.g., Foursquare) may use the service to check-into the venue that he visits shortly after he enters the venue. This user's incentive for checking-in early during his visit is to try to get a coupon via the location-based service before the user proceeds to perform an activity such as to order and eat dinner. As another example, the user may log his location on an online social network (e.g., Facebook) or a user-review web service (e.g., Yelp) shortly before leaving a venue if the user had a good experience at the venue (e.g., liked the food and/or service from a restaurant). This user may share his location and a comment about his experience via the online social network or the user-review service as a way to recommend the venue to others, or sometimes as a way to vent about a bad experience at the venue.

In some embodiments, the system can use knowledge about which portion of a visit each person uses to share his location to determine the likely start-time and end-time for their visit. The system can analyze the set of location events from the various individuals to determine a first cluster of location events that are associated with an activity start-time (operation 506), and determines a second cluster of location events that are associated with an activity end-time (operation 508).

In some embodiments, the system may detect the two clusters by applying K-means clustering to the set of location events by setting K to a value of 2 to detect the two clusters. The system can remove the dates from the location event timestamps, and converts the hours and minutes into a total minute number.

In some embodiments, the system may also determine which location events to assign to each cluster based on a service used to gather the location event, and/or based the corresponding user's demographic. Man users may “check-into” a location earlier during a visit if they are using a location-based service that gives them an incentive to do so, or if they are using a location-based service that can provide location-based content to the user (e.g., food recommendations for a restaurant). On the other hand, many users may share or “like” a venue later during the visit if they are using an online social network (or other social media services) to comment or write a review on their experience. Also, younger users may be more likely to share a visit to a venue earlier in a visit than older users.

Further, the system may determine which location events to assign to each cluster based on user-generated content that accompanies the location event. If the system determines that the location event includes content that contemplates a future action (e.g., a comment written in future tense or a picture that shows a food menu), the system can determine that the location event corresponds to the start of the activity (e.g., the user may have been seated at a restaurant within the last five minutes). However, if the system determines that the location event includes a comment that describes an activity that has happened and/or that is written in a past tense (e.g., a user recommending a restaurant or food item), the system may determine that the location event corresponds to the end of the activity.

Once the system has generated the two location-activity clusters, the system can determine the activity start-time for the activity type by computing an average time value or the total time value for the location events of the first cluster (operation 510). Similarly, the system can determine the activity end-time for the activity type by computing an average time value or a total time value for the location events of the second cluster (operation 512). The system can compute a duration for the activity type based on the activity start-time from the first cluster and the activity end-time from the second cluster (operation 514), for example, by computing a difference in the average or total time values for the two clusters (e.g., by subtracting the activity start-time from the activity end-time).

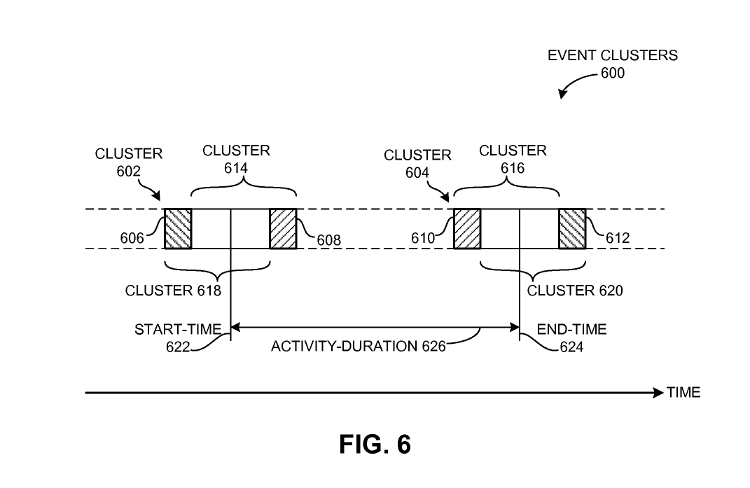

FIG. 6 illustrates exemplary location-event clusters 600 in accordance with an embodiment. Clusters 600 includes a cluster 602 and a cluster 604 along a timeline, such that each cluster includes a plurality of location events for a certain activity type and that are associated with one or more users. Specifically, cluster 602 includes a plurality of location events that are associated with a start of an activity, which results in cluster 602 occurring earlier in the timeline. Further, cluster 604 corresponds to a plurality of location events that are associated with an end of an activity, which results in cluster occurring later in the timeline. To compute an activity duration 626 for the activity type, the system computes a start-time 622 for cluster 602, computes an end-time 624 for cluster 604, and computes activity-duration 626 by subtracting start-time 622 from end-time 624. The system can compute start-time 622 and end-time 624 for clusters 602 and 604, respectively, by computing an average or a median of the timestamps for each clusters' set of location events.

In some occasions, it is possible that cluster 602 and cluster 604 may overlap along the timeline (not shown) given that some users may perform an activity significantly earlier than other users. However, the effects that these variations in activity time between different users (or even by the same user) have on the activity-duration time decrease as the sample size of historical activities increases, and as the number of users in the group increases.

Further, it is likely that cluster 602 and cluster 604 may include location events that do not correspond to the start or the end of an activity, respectively. For example, cluster 602 may include some location events that were generated before the user began an activity (e.g., while the user waited in line to enter a popular restaurant or public attraction), or while the user was performing the activity or had finished performing the activity. Also, cluster 604 may include some location events that were generated before or while the user was performing an activity, or significantly after the user had completed the activity (e.g., to comment on a recent activity after the user arrived back at home or at work).

In some embodiments, the system can remove the possibly erroneous location events from each cluster by removing a predetermined or a derived number of location events from each end of the timeline. For example, the system can remove portion 606 and 608 from cluster 602, and can remove portion 610 and portion 612 from cluster 604. The system can select the location events to remove from the starting end or the trailing end of a cluster by computing a standard deviation for the distribution of location events along the cluster, and selecting a number of standard deviations from the end of the cluster (e.g., selecting two standard deviations). Alternatively, the system can determine the number of location events to remove from the starting end or from the trailing end of a cluster by computing and selecting a percentage of location events from the end of the cluster (e.g., selecting 10%).

In some embodiments, the system can under-estimate the magnitude of activity-duration 626 by removing starting portion 606 of cluster 602 to produce a cluster 614, and by removing ending portion 612 of cluster 604 to produce a cluster 616. Doing so moves start-time 622 toward the right of the timeline, and moves end-time 624 toward the left of the timeline, which produces a smaller value for activity-duration 626.

The system can also over-estimate the magnitude of activity-duration 626 by removing ending portion 608 of cluster 602 to produce a cluster 618, and by removing starting portion 610 of cluster 604 to produce a cluster 620. Doing so moves start-time 622 toward the left of the timeline, and moves end-time 624 toward the right of the timeline, which produces a larger value for activity-duration 626.

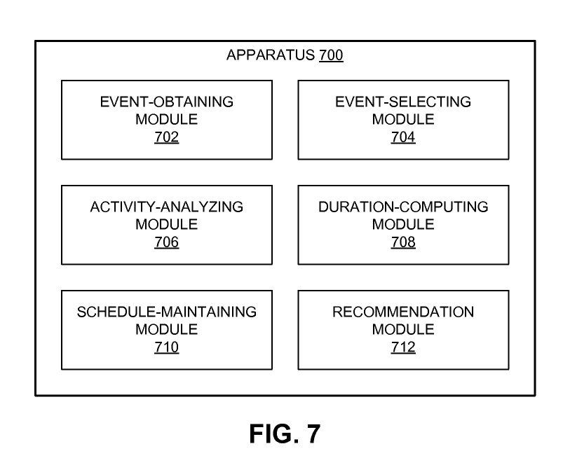

FIG. 7 illustrates an exemplary apparatus 7600 that facilitates computing an activity-duration time for an activity type in accordance with an embodiment. Apparatus 700 can comprise a plurality of modules which may communicate with one another via a wired or wireless communication channel. Apparatus 700 may be realized using one or more integrated circuits, and may include fewer or more modules than those shown in FIG. 7. Further, apparatus 700 may be integrated in a computer system, or realized as a separate device which is capable of communicating with other computer systems and/or devices. Specifically, apparatus 700 can comprise an event-obtaining module 702, an event-selecting module 704, an activity-analyzing module 706, a duration-computing module 708, a schedule-maintaining module 710, and a recommendation module 712.

In some embodiments, event-obtaining module 702 can obtain a plurality of location events associated with one or more users. For example, event-obtaining module 702 can include a communication module to communicate with one or more online social-media services (e.g., an online social network, a location-based social-media service, etc.) that can provide location events for these users. Event-selecting module 704 can select, from the plurality of location events, a set of location events associated with an activity type.

Activity-analyzing module 706 can determine, from the set of location events, an activity start-time and an activity end-time for the activity type. Duration-computing module 708 can compute an activity-duration time for the activity type based on the determined activity start-time and the activity end-time.

Schedule-maintaining module 710 can automatically maintain a collection of scheduled activities for a user based on an expected duration for these activities. Recommendation module 712 can recommend activities to add to a user's schedule based on an expected duration for the recommended activity. Further, recommendation module 712 can also recommend advertisements and/or incentives (e.g., coupons, gifts, etc.) for a user based on the user's current or scheduled activity and the duration for the activity (e.g., to provide the advertisement and/or incentive to the user shortly before the user finishes one activity and/or shortly before the user begins another activity).

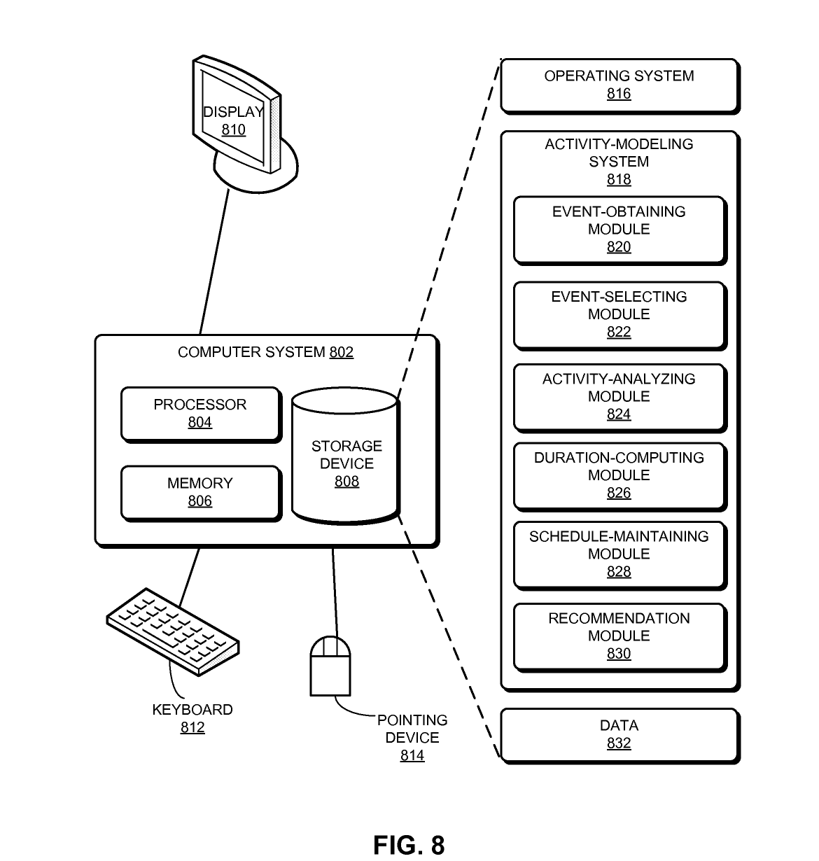

FIG. 8 illustrates an exemplary computer system 802 that facilitates computing an activity-duration time for an activity type in accordance with an embodiment. Computer system 802 includes a processor 804, a memory 806, and a storage device 808. Memory 806 can include a volatile memory (e.g., RAM) that serves as a managed memory, and can be used to store one or more memory pools. Furthermore, computer system 802 can be coupled to a display device 810, a keyboard 812, and a pointing device 814. Storage device 808 can store operating system 816, an activity-modeling system 818, and data 826.

Activity-modeling system 818 can include instructions, which when executed by computer system 802, can cause computer system 802 to perform methods and/or processes described in this disclosure. Specifically, activity-modeling system 818 may include instructions for obtaining a plurality of location events associated with one or more users (event-obtaining module 820). Further, activity-modeling system 818 can include instructions for selecting, from the plurality of location events, a set of location events associated with an activity type (event-selecting module 822). Activity-modeling system 818 can also include instructions for determining, from the set of location events, an activity start-time and an activity end-time for the activity type (activity-analyzing module 824). Activity-modeling system 818 can also include instructions for computing an activity-duration time for the activity type based on the determined activity start-time and the activity end-time (duration-computing module 826).

Activity-modeling system 818 can also include instructions for automatically maintaining a collection of scheduled activities for a user based on an expected duration for these activities (schedule-maintaining module 828). Activity-modeling system 818 can also include instructions for recommending activities to add to a user's schedule based on an expected duration for the recommended activity, and/or for recommending advertisements and/or incentives for a user based on the user's current or scheduled activity and the duration for the activity (recommendation module 830).

Data 832 can include any data that is required as input or that is generated as output by the methods and/or processes described in this disclosure. Specifically, data 832 can store at least a user profile for one or more users, location events for the one or more users, category information for a plurality of activity types, and activity models for the plurality of activity types.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
selecting, from a plurality of location events, a set of location events associated with an activity type, wherein a respective location event indicates a time at which a user performed an activity related to the activity type;
determining, from the set of location events, an activity start-time and an activity end-time for the activity type; and
computing an activity duration for the activity type based on the determined activity start-time and the activity end-time.

2. The method of claim 1, wherein the location event also indicates at least one of:
a user identifier;
a geographic location;
a venue identifier;
a venue type;
an activity identifier;
an activity type; and
a text description of the activity.

3. The method of claim 1, wherein the activity duration indicates one or more of:
a participation time of an activity;
a commute time between venues for a first activity and a second activity;
a time interval between a first activity and a second activity;
a wait period before performing an activity; and
a preparation time for an activity.

4. The method of claim 1, wherein selecting the set of location events associated with the activity type involves determining whether the user's location events correspond to a trace of periodic location events or a trace of manual location events.

5. The method of claim 4, further comprising:
responsive to determining that the location events correspond to a trace of periodic location events:
detecting, from the plurality of location events, one or more location-event sequences, wherein a respective location-event sequence includes location events that correspond to a common activity; and
selecting the set of location events to include a sequence of location events for one or more activities of the activity type.

6. The method of claim 5, wherein determining the activity start-time and activity end-time involves:
selecting the activity start-time for a respective activity based on an earliest location event for the respective activity's location-event sequence; and
selecting the activity end-time for the respective activity based on a latest location event for the respective activity's location-event sequence.

7. The method of claim 5, wherein computing the activity duration for the activity type involves:
computing an activity duration for a respective activity based on the determined activity start-time and activity end-time for the respective activity; and
computing an average duration for the activity type based on activity durations for one or more activities of the activity type.

8. The method of claim 4, further comprising:
responsive to determining that the location events correspond to a trace of manual location events:
identifying one or more users with a similar behavior pattern;
selecting the set of location events to include events for the activity type from the one or more users;
determining, from the set of location events, a first cluster of location events associated with an activity start-time; and
determining, from the set of location events, a second cluster of location events associated with an activity end-time.

9. The method of claim 8, wherein determining the activity start-time for the activity type involves computing an average time value for the first cluster; and
wherein determining the activity end-time for the activity type involves computing an average time value for the second cluster.

10. The method of claim 8, wherein identifying the one or more users with a similar behavior pattern involves determining that the one or more users have similar parameters for one or more of:
a work schedule;
a commute schedule;
a sleep schedule;
a geographic location;
a job title;
a career type; and
an activity type.

11. A non-transitory computer-readable storage medium storing instructions that when executed by a computer cause the computer to perform a method, the method comprising:
selecting, from a plurality of location events, a set of location events associated with an activity type, wherein a respective location event indicates a time at which a user performed an activity related to the activity type;
determining, from the set of location events, an activity start-time and an activity end-time for the activity type; and
computing an activity duration for the activity type based on the determined activity start-time and the activity end-time.

12. The storage medium of claim 11, wherein the location event also indicates at least one of:
a user identifier;
a geographic location;
a text description of a location;
a venue identifier;
a venue type;
a text description of a venue;
an activity identifier;
an activity type; and
a text description of the activity.

13. The storage medium of claim 11, wherein selecting the set of location events associated with the activity type involves determining whether the user's location events correspond to a trace of periodic location events or a trace of manual location events.

14. The storage medium of claim 13, wherein the method further comprises:
responsive to determining that the location events correspond to a trace of periodic location events:
detecting, from the plurality of location events, one or more location-event sequences, wherein a respective location-event sequence includes location events that correspond to a common activity; and
selecting the set of location events to include a sequence of location events for one or more activities of the activity type.

15. The storage medium of claim 14, wherein determining the activity start-time and activity end-time involves:
selecting the activity start-time for a respective activity based on an earliest location event for the respective activity's location-event sequence; and
selecting the activity end-time for the respective activity based on a latest location event for the respective activity's location-event sequence.

16. The storage medium of claim 14, wherein computing the activity duration for the activity type involves:
computing an activity duration for a respective activity based on the determined activity start-time and activity end-time for the respective activity; and
computing an average duration for the activity type based on activity durations for one or more activities of the activity type.

17. The storage medium of claim 13, wherein the method further comprises:
responsive to determining that the location events correspond to a trace of manual location events:
identifying one or more users with a similar behavior pattern;
selecting the set of location events to include events for the activity type from the one or more users;
determining, from the set of location events, a first cluster of location events associated with an activity start-time; and
determining, from the set of location events, a second cluster of location events associated with an activity end-time.

18. The storage medium of claim 17, wherein determining the activity start-time for the activity type involves computing an average time value for the first cluster; and
wherein determining the activity end-time for the activity type involves computing an average time value for the second cluster.

19. An apparatus comprising:
an event-selecting module to select, from a plurality of location events, a set of location events associated with an activity type, wherein a respective location event indicates a time at which a user performed an activity related to the activity type;
an activity-analyzing module to determine, from the set of location events, an activity start-time and an activity end-time for the activity type; and
a duration-computing module to compute an activity duration for the activity type based on the determined activity start-time and the activity end-time.

20. The apparatus of claim 19, wherein while selecting the set of location events associated with the activity type, the event-selecting module is further configured to determine whether the user's location events correspond to a trace of periodic location events or a trace of manual location events.

21. The apparatus of claim 20, wherein responsive to the event-selecting module determining that the location events correspond to a trace of periodic location events, the event-selecting module is further configured to:
detect, from the plurality of location events, one or more location-event sequences, wherein a respective location-event sequence includes location events that correspond to a common activity; and
select the set of location events to include a sequence of location events for one or more activities of the activity type.

22. The apparatus of claim 21, wherein while determining the activity start-time and activity end-time, the activity-analyzing module is further configured to:
select the activity start-time for a respective activity based on an earliest location event for the respective activity's location-event sequence; and
select the activity end-time for the respective activity based on a latest location event for the respective activity's location-event sequence.

23. The apparatus of claim 21, wherein while computing the activity duration for the activity type, the duration-computing module is further configured to:
compute an activity duration for a respective activity based on the determined activity start-time and activity end-time for the respective activity; and
compute an average duration for the activity type based on activity durations for one or more activities of the activity type.

24. The apparatus of claim 20, wherein responsive to the event-selecting module determining that the location events correspond to a trace of manual location events, the event-selecting module is further configured to:
identify one or more users with a similar behavior pattern; and
select the set of location events to include events for the activity type from the one or more users;
determining, from the set of location events, a first cluster of location events associated with an activity start-time; and
determining, from the set of location events, a second cluster of location events associated with an activity end-time.

25. The apparatus of claim 24, wherein while determining the activity start-time for the activity type, the activity-analyzing module is further configured to compute an average time value for the first cluster; and
wherein while determining the activity end-time for the activity type, the activity-analyzing module is further configured to compute an average time value for the second cluster.
